(19) United States
(12) Patent Application Publication
(10) Pub. No.: US 2008/0249882 A1
(43) Pub. Date: Oct. 9, 2008

(54) System for purchasing commercial products and items having monetary value with entertainment content

(76) Inventor: Margaret M. Spolar, Montrose, PA (US)

Correspondence Address: Mark Levy;HINMAN, HOWARD & KATTELL, LLP, 80 Exchange Street, P.O. Box 5250, BINGHAMTON, NY, 13901, US

(21) Appl. No.: 12/156,974

(22) Filed: Jun. 6, 2008

Related U.S. Application Data
(63) Continuation-in-part of application No. 11/985,393, filed on Nov. 15, 2007.
(60) Provisional application No. 60/872,860, filed on Dec. 5, 2006.
(60) Provisional application No. 61/065,521, filed on Feb. 13, 2008.

(51) Int. Cl. G06Q 30/00; G06Q 90/00

(52) U.S. Cl. 705/14

(57) ABSTRACT

A single entity for providing entertainment content with the purchase of a commercial product or other item representing monetary funds, such as a telephone card, gift card, or bank card. A first medium holds the entertainment content, and the commercial item can be any product sold at a retail store or on the Internet. The commercial product and/or the entertainment medium includes at least one serial number. A mechanism is also provided for qualifying a customer to participate in a contest.

### RELATED PATENT APPLICATIONS

The present patent application is a continuation-in-part of copending U.S. patent application Ser. No. 11/985,393, filed Nov. 15, 2007 for ENTERTAINMENT, BUSINESS TRANSACTION, INFORMATION, TELECOMMUNICATIONS INTERNET PACKAGE, which was a continuation-in-part of U.S. provisional patent application Ser. No. 60/872,860, filed Dec. 5, 2006, for ENTERTAINMENT, BUSINESS TRANSACTION, INFORMATION, TELECOMMUNICATIONS PACKAGE; and of copending U.S. provisional patent application Ser. No. 61/065,521, filed Feb. 13, 2008, all of which are hereby incorporated by reference.

### FIELD OF THE INVENTION

The invention pertains to methods and apparatus for distributing commercial products and items having monetary value, such as time on telephone cards, gift cards and bank cards, with entertainment content and, more particularly, to a system of combining the purchase of such products and items and entertainment content ordered as part of the same transaction.

### BACKGROUND OF THE INVENTION

Commercial products or items and entertainment content are used every day. In fact, a high percentage of the consumer fee for entertainment content such as DVDs and CDs, whether used to hold music, movies, games, data or computer software for example, is for the purchase of these products. Likewise commercial products such as, but not limited to, food items, consumer electronics, electrical products, hardware, automotive and accessories therefor, textile items, toys, sporting goods, specialty items, specialty services, stationery, crafts, books, memorabilia of all sorts, footwear, health and beauty items, collectibles, home and garden, jewelry, linens, clothing, pottery, glassware, computers, and computer products, computer services, gift certificates, gift cards, cameras, art, antiques, and the like, phone cards, credit cards, debit cards, and entertainment products, are used on a daily basis and distributed in large quantities usually in a reliable, inexpensive package.

Many products, services, and information can be purchased on retail shelves or accessed for purchase via the Internet. The consumer searches the best way to shop. Whether the consumer shops using retail or Internet, he is usually in search of an easier way in which to complete purchases.

Nielsen's consumer packaged goods (CPG) research shows that while shopping frequency across most retail supercenters, which enable consumers to combine shopping trips with more items in one store, continues to show growth. Alternative channels, including hardware/home improvement stores, office supply stores, automobile supply stores and bookstores are increasing the level of competition for traditional retailers and increasing the distribution opportunities for manufacturers.

Certain applications blur the distinction between entertainment content and commercial products, such as Blackberry service, Wi-Fi, Yahoo, satellite radio, San Disk memory cards, subscription services, broadband Internet service, cable TV, direct TV, DMX digital music, iPhone, Sansa Connect music players, and electronic devices.

Retail stores represent a friendly way for consumers to shop in a more personal way, in which the consumer can see and touch the product before he purchases it. The consumer can view the difference between other products and read labels more closely. The retail store develops a relationship with consumers, whereas the seller understands through its service what customers expect.

Retail purchases are made by way of cash, VISA, ATM, debit, gift cards, and the like. Electronic data capture (EDC) magstripe-card swipe terminals have become ubiquitous, requesting the user to swipe his own card at the checkout station.

A credit card is a thin plastic card, usually 3⅛ inches by 2⅛ inches in size, which contains identification information such as a signature or picture, and authorizes the person named on it to charge purchases or services to his account, charges for which he is billed periodically. Under the plan, the bank credits the account of the merchant as sales slips are received and assembles charges to be billed to the cardholder at the end of the billing period. The cardholder, in turn, pays the bank either the entire balance or in monthly installments with interest.

Separate distribution of products typically has no advantage for the consumer. For years, music on CD, mini-CD, or DVD, books on DVD, movies on DVD, events on DVD, sports on DVD, exercise programs on DVD, stand up comedy on DVD, magicians on DVD, cooking on DVD, history on DVD, the Bible on DVD, educational programming on DVD, training programming on DVD, drivers training on DVD, gardening on DVD, health on DVD, dance on DVD, concerts on DVD, magic shows on DVD, yoga on DVD, computer games, Game Boy Advance, Nintendo DS, Nintendo GameCube, Nintendo WII, Xbox, Play Station 2, Play Station 3, PSP, and the like have been sold separately.

The Internet, as opposed to brick-and-mortar retail sales, has created a new set of connections between buyers and sellers and offers other possibilities for creating opportunities for businesses to deal with customers. Moreover, the Internet is a medium that can excite customer interest, can close sales quickly and conveniently, and can do so cost-effectively. It enables a customer to pay for goods or services by using credit cards.

Internet payment processing involves transactions over an open Internet connection, so the transaction can be performed online, potentially even on a web server itself. Internet transaction services typically provide an application programming interface (API), which is an HTML-type input terminal for manual entry and full online reports of transactions and batches thereof. Transaction processors are separate from the banks that provide a merchant account, although some providers provide a single transaction statement, seemingly providing a single service.

To avail himself of these services, a consumer must have a computer, he must be connected to the Internet, and he must use a web browser. The consumer must visit a web site to find the item that best services his needs. Once the consumer decides to make a purchase, the web pages show the consumer how to place an order and to pay for the product or service.

If the consumer chooses to use a credit card, he must key his credit card details into a web form. Those details include the type of card (e.g., Bankcard, MasterCard, or Visa), the credit card number, the card's expiry date, and the name as displayed thereon. The Internet Service Provider (ISP) receives those details across the Internet or, when purchasing at a retail store, at the counter.

Internet merchant accounts are separate bank accounts that are capable of receiving credit card payments from credit card providers. Internet merchant accounts typically do not hold funds for an extended period of time such a typical bank account, but usually transfer payments to another bank account designated by the Internet merchant on a daily basis.

The payment gateway account is the online credit card processor or transaction handler which is capable of hooking into credit card accounts belonging to the online consumer and the merchant's Internet merchant account. The payment gateway handles the verification and transfers requests. The term account when used with payment gateway is not the funds holding account but rather a service account that typically has a log in which it configures the payment gateway settings.

Merchant services providers set number up merchant accounts and a Gateway Credit. Merchant accounts are bank accounts specifically designed to accept and transfer credit card funds via the credit card processing network. Cards are processed through an Internet merchant account either manually through an in-store credit card terminal, online through a web based terminal page, or automatically through an associated payment gateway provider linking to the merchant's web shopping cart.

Three primary components are part of the standard merchant account fee structure:

1. One time fees

2. Recurring monthly fees

3. Transaction related fees
per transaction (set fee such as 30 cents)
per order totals (percentage fee such as 2.35%)

These same items apply to the payment gateway fee structure:

1. One time fees

2. Recurring monthly fees

3. Transaction fees

A third party payer merchant account alternative payment method such as PayPal can be used. In this payment method, Internet purchases are charged as if the third party payment service is the seller. Though the actual merchant sets up the store with products and pricing. The third party processor is technically the seller. The actual merchant then becomes a supplier and drop shipper.

ECommerce or a gateway like USA Payment secures Internet payment processing. A merchant account, sometimes referred to as Internet/MoTo account, is needed. Merchant account companies act as a middleman between the merchant and the credit card provider and determines whether the applicant meets the provider's requirements.

Entertainment products store data such as text, graphics, photo, audio or video files. The consumer may chose his entertainment products in physical form, such as on a CD, a DVD, a ROM, a hardware device, an electronic device, and any other suitable medium.

Downloading files from the Internet is usually a straightforward process. The first step is saving the file to the user's drive on his local system. Downloaded files are typically in compressed or encoded format such as ZIP (Windows) or SIT (Macintosh) or Binhex (HQX). Encoding files ensures more reliable data transfer. Encoded files must first be decoded before they can be accessed. Decompression software such as WinZip or Stuffit expander can be used to open or extract these types of files. On some browsers, the folder in which the file is to be stored is a preference set in the decompression software using compressed files. Binhex, binary or MacBinary (BIN) files are common ways of encoding files for transmission over the Internet.

Downloading is also possible using MP3 files from the Internet to their content on a computer, listening to them on a portable MP3 player, or burning them to CDs. The MP3 format makes song files small enough to move around on the Internet in a reasonable amount of time.

Napster represents a different way to distribute MP3 files. Instead of storing the songs on a central computer, the songs reside on individual users' machines. Downloading a song using Napster is actually downloading the song from another person's machine.

There are many ways to process and to hold information, such as computers, databases, systems, memory, Internet connections, hardware, and the like. Databases can contain information to allow tracking of items and transactions based on conditions, functions, attributes, labels, characters, and systems. One kind of database is that which is used as a structured collection of records or data which can be organized or categorized to structure, model, or support a model. Network models tend to store records with links to other records. The Internet can act as a model to store transaction data. An online database is a database accessible through the Internet and, as such differs from a local database held in an individual computer, system, or its attached storage, such as a CD or DVD.

Promotional schemes have existed since the first products and items were offered for sale. Nowadays, it is not unusual to find that a product, such as a printer, may have a coupon associated therewith. Once the user buys the printer, he can redeem a coupon to receive a toner cartridge by mailing his coupon or communicating the information thereon via telephone or email. Moreover, certain goods and services are packaged with information regarding rewards. For example, the purchase of an airline ticket may qualify the user to redeem gifts based on the number of miles represented by the ticket sale.

All of these incentives require delayed gratification on the part of the consumer, who must take one or more separate steps to redeem the coupon or rewards for his benefit. In this age of instant gratification, however, the value of incentives is diminished with the effort required for the customer to take advantage thereof. In other words, the extra steps in redeeming a coupon or rewards act as impediments or obstacles to the incentive program.

What is needed is a system for encouraging customers to purchase commercial products, which system delivers immediate satisfaction for the customer. Eliminating extra procedures and equipment on the part of the customer to cash in on the incentives would be an important step in this direction.

### SUMMARY OF THE INVENTION

In accordance with the present invention, there is provided a single entity for providing entertainment content with the purchase of a commercial product or other item having monetary value. A medium holds the entertainment content, and the commercial product or item can be any product sold at a retail store or on the Internet. The commercial product and/or the entertainment medium includes at least one serial number. A mechanism is also provided for qualifying a customer to participate in a contest.

### BRIEF DESCRIPTION OF THE DRAWINGS

A complete understanding of the present invention may be obtained by reference to the accompanying drawings, when considered in conjunction with the subsequent detailed description, in which:

FIG. 1a is a schematic view of a package in accordance with the invention, showing a telecommunication medium and an entertainment medium;

FIG. 1b is a schematic view of the reverse side of the package shown in FIG. 1a;

FIG. 2 is a flow chart of user operations in utilizing a telecommunications media (e.g., a telephone card);

FIG. 3 is a flow chart of manufacturer/distribution operations in acquiring and distributing entertainment content and telecommunications time;

FIG. 4 is a flow chart depicting user operations in participating in a contest relating to the inventive package;

FIG. 5 is a block diagram showing data flow from point of purchase to credit card and then to delivery;

FIG. 6 is a flow chart of user operations in utilizing a telecommunications media (e.g., a telephone card);

FIG. 7 is a flow chart of manufacturer/distribution operations in acquiring and distributing entertainment content and telecommunications time;

FIG. 8 is a flow chart depicting user operations in participating in a contest relating to the inventive package;

FIG. 9 is a block diagram depicting Internet-based transaction of a consumer purchasing goods or services using a credit card;

FIG. 10 is a block diagram showing flow from point of purchase of a commercial item through the consumer and thence to the medium containing entertainment content;

FIG. 11 is a flow chart of manufacturer/distribution operations in acquiring and distributing entertainment content and selling the commercial item;

FIG. 12 is a flow chart depicting user operations in participating in a contest relating to the inventive entity; and

FIG. 13 is a flow chart of merchant operations for commercial items purchased over the Internet.

### DETAILED DESCRIPTION OF THE PREFERRED EMBODIMENT

The invention is a single entity for providing entertainment content with the purchase of a commercial product or monetary value item. A first medium holds the entertainment content, and the commercial item can be any product sold at a retail store or on the Internet. Commercial items or products may be, for example, foods, clothing, toys, health and beauty products, home and garden products, jewelry, linens, automotive, etc. Entertainment content is also storable on commercial products and may reside on such items as CDs, DVDs, games, electronic devices, downloadable files representative thereof, media that includes information representative of monetary funds, etc.

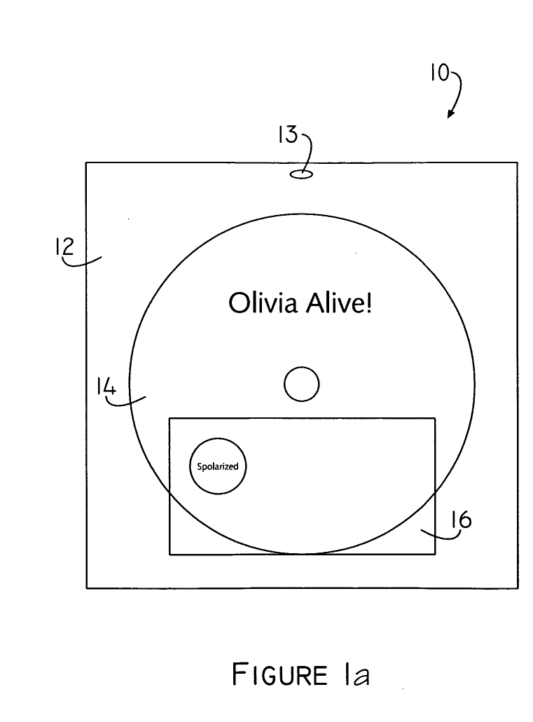

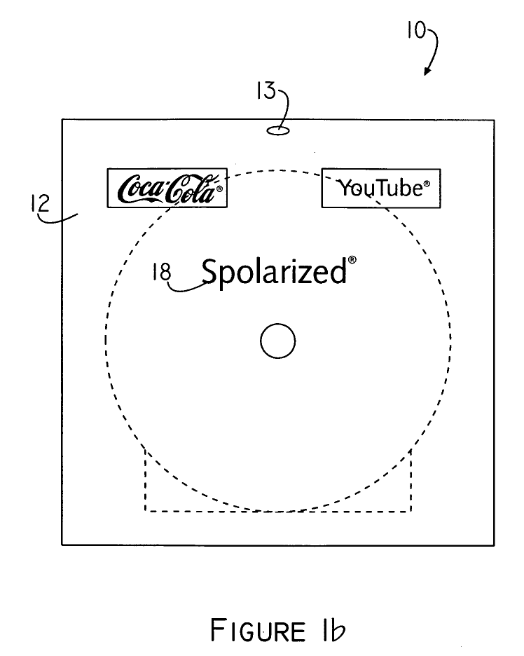

Referring now to FIGS. 1a and 1b, there is shown generally at reference number 10 a combination package or collection. A cardboard, laminated cardboard or plastic substrate 12 has an aperture 13 for hanging on a store display rack, not shown. Substrate 12 may be any suitable material for carrying out its function. Written material, such as the advertisement for a Spolarized® product, for example shown as reference number 18, can be printed on either or both front and rear sides of substrate 12. The written material may be used for advertising products of other manufacturers or vendors.

Entertainment media in the form of a CD, mini-CD or DVD 14 is attached and carried by the substrate 12. CDs and DVDs can be produced in any of a number of formats such as rewritable CD-R, DVD+R, high density, etc. It should be understood that other forms of the entertainment media such as, but not limited to entertainment cards (i.e., a card representative of monetary funds for entertainment content), can be provided, as desired, without departing from the scope of the invention. Since entertainment includes providing amusement (events, performances, recreational activities) to at least one person, other forms of the entertainment media include but are not limited to digital files residing on electronic devices such as memory sticks, non-volatile memory cards, MP3 players, optical storage disks, multimedia cards, SanDisk, Apple iPods, solid state devices (ROMs), Bluetooth handsets, Blackberry devices, HP iPAQ, Palm, Zune to Zune, iFlops, MP3 pillows, Virgin Mobile, Slice, Zen Micro Photo MP3, T-Mobile, cellular telephones, Xbox, Nintendo WII, Nintendo DS, Nintendo GameCube, Gameboy, computer games, PSP, Play Station, TracFone, Chocolate, INpulse, Firefly, U3 Data Traveler, Digital MP3 WMA, ZenV, Walkman, MP3 FM tuner, iMove Boom Box, iPod Nano, iPod Talking Shoe, Audiovox Xpress, Micro SD, XM card, satellite radio digital music, Flicker Photos, mobile prepaid plan cards, pay-as-you-go wireless, Internet service cards, laptop cards, mobile phone cards, landline telephones, cellular phones, Virgin Mobile, Slice, iPhone, Bluetooth, camera phones, Motorola RAZR, NeXus satellite radio, MP3/DVD/CD/WMA receiver iPod and XM-ready, Ticketmaster, band credit cards, debit cards, ATM cards, Internet service, gift card, membership card, rewards card, promotion card, celebrity card, ring tones, photo card, merchandise cards, entertainment cards, Amp'd card, promotional cards, wireless gift card, You Tube, Kiosk, music downloads, movie downloads, parents cards, points cards, electronic video cards, Free Leader, GPhone, mobile caller, itune7, PDA's, Trac-Fone, WiFi, Blue Ray, mobile web and email, SanDisk Sansa, CB radio, walkie-talkie, digital cable, HBO Cinemax, DVR service, boost mobile, Xing tone software, Broadband cards, cash and non-cash rewards, Travel & Entertainment cards (T&E), house cards, Napster, Mobile TV, air travel cards, Sunnysoft calling cards, cards, Pennytalk, Microsoft Max, Photo MP3, Corel Snapfire, cash- and non-cash rewards, points cards, satellite radio digital music, Internet-based applications, including Flicker Photos, iPhone, T-Mobile, STI mobile, Net10, Edge and WiFi laptop PC cards (T-Mobile), Smartphones, Express cards, T-Mobile to Go, Text messaging, Java Games, WAV/AAC/AACT music players, walkman, PC card, USB modem, video share calling, micro SD, mini SD, Media players, MMS, QuickShare, messaging packing MSN, YAHOO, AOL, ICQ, AIM, Billboards, multimedia messaging, data download speed burst, upload burst, 2way SMA, dual band, Quad-Band(GPRS/EDGE) worldwide communication, instant messenger, Edge technology high speed data, Yahoo Messenger, and the like.

The separate distribution of each product typically has no advantage for the consumer. For years, music on CD, mini-CD, or DVD, books on DVD, movies on DVD, events on DVD, sports on DVD, exercise programs on DVD, stand up comedy on DVD, magicians on DVD, cooking on DVD, history on DVD, the Bible on DVD, educational programming on DVD, training programming on DVD, drivers training on DVD, gardening on DVD, health on DVD, dance on DVD, concerts on DVD, magic shows on DVD, yoga on DVD, computer games, Game Boy Advance, Nintendo DS, Nintendo GameCube, Nintendo WII, Xbox, Play Station 2, Play Station 3, PSP, and the like have been sold separately.

A registration serial number, not shown, is embedded in the entertainment media 14 and optionally printed on substrate 12 and/or on a label therefore, Advertising can also be printed on media labels. The serial number is discussed in greater detail below. Moreover, printed material, such as advertising 18 (FIG. 1b) can be printed on entertainment media 14. Such printed material 18 can likewise be disposed on the face and/or obverse of entertainment media 14. Moreover, advertising in the form of sound and/or images can be embedded before, during or after the content stored on the entertainment media 14, itself, for play or display to the user.

Telecommunication media in the form of a plastic or other suitable physical card 16 is attached and carried by the substrate 12. It should be understood that other telecommunications media can be provided, as desired, without departing from the scope of the invention. In the preferred embodiment, plastic card 16 has a magnetic strip, not shown, attached to one surface thereof. The strip includes digital information representative of the number of telephone calling minutes purchased. In applying the magnetic strip, a suitable machine prints the card 16. The card 16 then is fed to a different machine that glues the strip not shown or a static bar to the card 16. The card 16 is then sent to a different machine that codes the bar. The magnetic strip is a thin layer of magnetizable material that is placed on conventional or rechargeable (PINGO®) phone cards, iPhone cards, land line telephone cards, smart cards with embedded IC chip(s), credit cards, targeted credit cards (gas cards, store cards, student cards, parent cards, teen credit cards, etc.) bank ATM cards, debit cards, no-fee cards, gift cards, international phone cards, prepaid phone cards, pay as you go cards, money cards, travel cards, monetary fund cards, club cards, dinner cards, mobile phone memory cards, mobile prepaid plan cards, Internet service cards, and laptop cards, mobile phone cards, cellular phones, T-mobile, Virgin Mobile, Slice, Bluetooth, Zune to Zune, iFlops, camera phones, Motorola RAZR, NeXus satellite radio, iPhone, MP3/DVD/CD/WMA receiver iPod and XM-ready, Ticketmaster, band credits cards, debit cards, ATM cards, Internet service, membership cards, rewards cards, promotional cards, celebrity cards, ring tones, photo cards, merchandise cards, iTune cards, eMusic cards, entertainment cards, cards, music download, free loader, parents load, electronic video games, Kiosks cards, mobile tracker, cash and non-cash cards, walkie talkie, Mobile TV, WiFi, Trac-Fone, ring tones, GPhone, cardless calling cards, Internet-based applications, QAV/AAC/AACT music player, and wireless gift cards.

The strip is a plastic material with magnetizable powder mixed in with it. The strip can be magnetized by exposing it to a strong magnetic field. Bits of the composition can be magnetized in different directions by a device that generates a strong magnetic field over a short distance. The strip can have many North and South poles on it. The numbers and locations of the poles are used to encode information.

The strip is read with a similar (or even the same) device that wrote it. The process also works in reverse. By moving the strip back and forth over a read head, voltages are induced in coils that can be amplified and recorded electronically, so that information can be sent to a computer. The PIN may activate through a mag strip, a bar code, etc., depending on which system and/or database terminal has been set up by the retail store to read PIN numbers. When the user purchases a phone card 16 at a register, the data are sent through the system that is in place with that retailer. The information is then sent to the carrier's central terminal to inform the carrier that the sale took place. The carrier then activates the PIN and sends a data wave to the partner.

As aforementioned, printed material such as advertising can be printed on either or both sides of substrate 12 on entertainment media 14, as well as on calling card/credit card, debit card, gift card, etc. 16.

Certain applications blur the distinction between entertainment and telecommunications, such as Blackberry service, WiFi, Yahoo, satellite radio (Sirius), San Disk memory cards, subscription services, broadband Internet service DMX digital music, iPhone, and Sansa Connect music players.

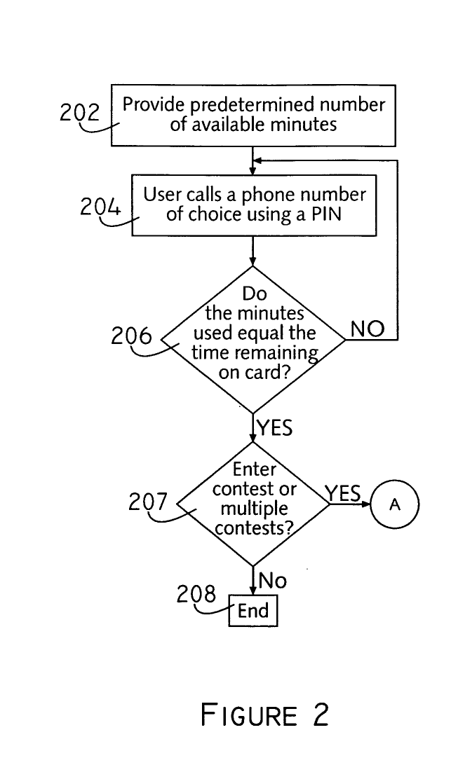

Referring now to FIG. 2, there is shown a flow chart of phone card operations. The card is provided with a predetermined number of minutes available, step 202.

A liaison company can be used to interact with retail stores and telecommunication companies. Such liaison companies typically receive a percentage of income for each minute purchased by the customer. In one embodiment of the invention, the telecommunications and entertainment company (TEC) also receives a percentage of income for each minute purchased by the consumer. A liaison is a point-of-service activation (POSA) and distribution partner for all major wireless carriers.

Phone cards are generally a prepaid method of making a long distance (domestic or international) call. Minutes means total time that can be used for one or more calls to one or more phone numbers (locations, area codes, countries). The cards can be used from any phone. Some prepaid phone cards can be refilled, usually by charging the additional cost to the user's credit card.

Prepaid phone cards represent telephone time a customer buys in advance. Users pay from $5 to $15, or more, up-front for local or long distance phone time. The amount of time bought depends on the rate-per-minute that is charged. The phone time is paid for in advance. Phone card companies keep track of how calling time is used by the PIN. Time can be added to some prepaid phone cards. The added cost can usually be billed to a credit card.

Pay as you go cards are prepaid mobile phone cards that are used with phones that the customer buys. Minutes are bought as needed. Prepaid cell phones allow the customer to pay for only the minutes needed.

For purposes of this disclosure, it should be understood that “telecommunications” includes but is not limited to landline telephones, cellular phones, T-mobile, Virgin Mobile, Slice, Bluetooth, Zune to Zune, iPhone, iFlops, camera phones, Motorola RAZR, NeXus satellite radio, MP3/DVD/CD/WMA receiver iPod and XM-ready, TracFone wireless, Chocolate, INpulse, Firefly, Ticketmaster, U3 Data Traveler, Walkman, ZenV, Impulse, Sirus Cable, Cable Service, Instant messaging, Internet Service and Communication, Television Communication, Radio Communication, Satellite Communication, Email, etc. Giving due respect to the adage, “time is money,” telecommunications time, as used herein, is considered to have a monetary value, so that items that have such monetary value are expressly considered herein to include but not be limited to telephone cards and the like.

The user calls a phone number using a PIN, step 204. Most prepaid phone cards display a toll-free access telephone number and PIN. The PIN can be provided by any one or more of the following techniques: printed numbers, bar codes, magnetic strips, or optical character recognition (OCR) printed symbols. Alternatively, this activation step 204 can be accomplished without the use of a predetermined PIN number and even with the use of a phone number.

Prepaid phone card companies have computers that use the user's PIN to keep track of the card usage—how much time the user has on the card in minutes or units. To make a phone call, the user dials the access number, enters the PIN, and at the voice prompt, enters the phone number of the party the user is trying to reach. A computer informs the user of how much time—or how many units—the user has left on the card, and how to use other features the card may offer. Typically, each unit equals one minute for a domestic call. If the prepaid phone card cannot be recharged—that is, if the user cannot buy additional minutes by phone for the card—the user must buy another card once the time is used up.

Carriers are responsible for the telephone lines that carry calls. Resellers buy telephone minutes from carriers. Issuers set the rates and provide toll-free customer service and access numbers.

The number of minutes remaining on the card equals the original number of minutes paid for, less time used with the card, rounded up, step 206. Rounding is the billing increment unit. One Minute Rounding means that the billing increment is one minute. A call for fifty seconds, for example, is billed as one minute. Three Minute Rounding means that the billing increment unit is three minutes. A call for seven minutes and fifty seconds is billed as nine minutes. One plus three Minute Rounding means that for calls less than one minute, the user is charged for one minute. For calls more than one minute, the first minute is charged one minute and the following minutes are charged at three minute increments. A call for two minutes and fifty seconds is billed as four minutes.

The user decides whether to enter a TEC contest, step 207. For purposes of this disclosure, a “contest” is intended to include, but not be limited to, a prize, a sweepstake, a chance and consideration for the acquisition thereof. The user can decide to enter the contest by following the directions on the package 10 (FIG. 1a). There may also be multiple contests available on the package. The user may enter as many of the contests as are available. The contests include but are not limited to membership rewards, shopping cards, retailer's cards, Sirius radio, cable or Internet service, best CD album, best artists, best lyrics, best song, best movie, best actor, best soundtrack, best director, best producer, best book, best game, Ticketmaster, event tickets, and the like.

It should be understood that landline service can be purchased and used in connection with the present invention, in which case a discount is available to encourage a user to maintain and retain his land line service. Minutes or cash payable to a user's bill can be claimed by a user who avails himself of the inventive product and services.

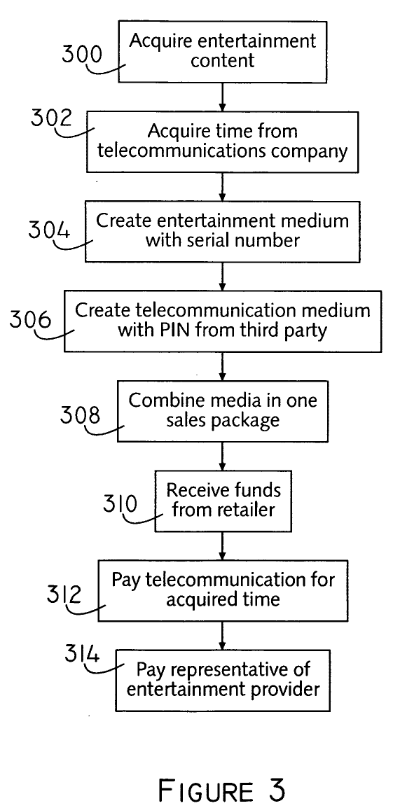

Referring now to FIG. 3, there is shown a flow chart of operations for acquiring and distributing entertainment content and telecommunications options. Entertainment content is acquired, step 300. The entertainment content may be movies on DVD, music on CD, music on mini-CD, books on DVD, stand up comedy on DVD, sports on DVD, events on DVD, exercise programming on DVD, music video on DVD, magician on DVD, history on DVD, the bible on DVD, dance on DVD, yoga on DVD, health on DVD, educational programs on DVD, gardening on DVD, magic shows on DVD, drivers training on DVD, cooking on DVD, stand up comedy on DVD, concerts on DVD, games, computer games on DVD, Game Boy, Nintendo DS, Nintendo GameCube, Nintendo WII, Play Station 2 and 3, PSP, entertainment cards that offer services, or gift cards for the purchase of certain entertainment products, and the like.

A license is acquired from the copyright holder for the use of music, movies, books, sports, events, games, exercise programming, computer games, Gameboy games, Gameboy Advance, Nintendo DS, Nintendo GameCube, Nintendo WII, Xbox, Playstation 2, Playstation 3, PSP, and the like. The content is in the form of a CD/DVD, but is not limited thereto. For example, other forms of expression (e.g., written material) are contemplated herein.

Time is acquired from one or more telecommunications companies, step 302. The purchased time is encoded on a magnetic strip across the phone card 16 (FIG. 1a). The time can be activated when sold, although certain phone cards are prepaid.

An entertainment medium is created with a serial number, step 304, the serial number being placed on the entertainment medium itself.

A telecommunications medium is created with a PIN number, step 306. The PIN is placed on the telecommunications card and/or bank credit card, debt card, ATM card, iTune, eMusic card, Internet service medium, gift card, membership card, rewards card, entertainment card, Ticketmaster, promotional card, celebrity card, and the like, which may or may not match other serial numbers within the package.

A liaison such as InComm Interactive Voice Response (IVR) system can give customers easy-to-follow prompts to enter the pin and account numbers located on their card or receipt. This information is communicated to the payment database at the InComm Data Center, which verifies the information and transmits it to the appropriate carrier for activation.

Handset activation technology is activated at the register. InComm has a direct connection with the major carriers and can automatically activate the headset by the electronic serial number (ESN).

A liaison company can be used to interact with retail stores and telecommunication companies. Such liaison companies typically receive a percentage of income for each minute purchased by the customer. In one embodiment of the invention, the telecommunications and entertainment company (TEC) also receives a percentage of income for each minute purchased by the consumer. A liaison is a point-of-service activation (POSA) and distribution partner for all major wireless carriers.

The telecommunications and entertainment media are combined in one package, step 308. Accordingly, the telecommunication and entertainment package now contains a phone card, a DVD or CD with entertainment programming, and a rewards contest. It should be understood, however, that for purposes of this disclosure, the single event that includes telecommunications and entertainment media may, in fact, be purchased at different times, at different locations, and via different methods (e.g., physical sale, mail order, email order, Internet sale, etc.), yet still be considered a single package, entity or transaction.

Funds are received from one or more retailers, step 310. The retailer reports the sale or rental of the telecommunications and entertainment package on a monthly basis, preferably, but other periodic or non-periodic time frames can be negotiated. The retailer forwards the money from the sale or rental of the telecommunication and entertainment package on a monthly or quarterly basis, but shorter or longer payment periods can be negotiated. For purposes of this disclosure, the words “sale”, “sell” and “selling” are intended to include the concepts of renting and rented.

Telecommunications companies are paid for the acquired time, step 312, by the TEC. Minutes are paid as they are used or may be paid all at once for the telecommunications and entertainment package when purchased.

A representative of the entertainment provider is paid, step 314. The provider of the entertainment receives funds after the telecommunications and entertainment package has been purchased and the money has been received from the sale.

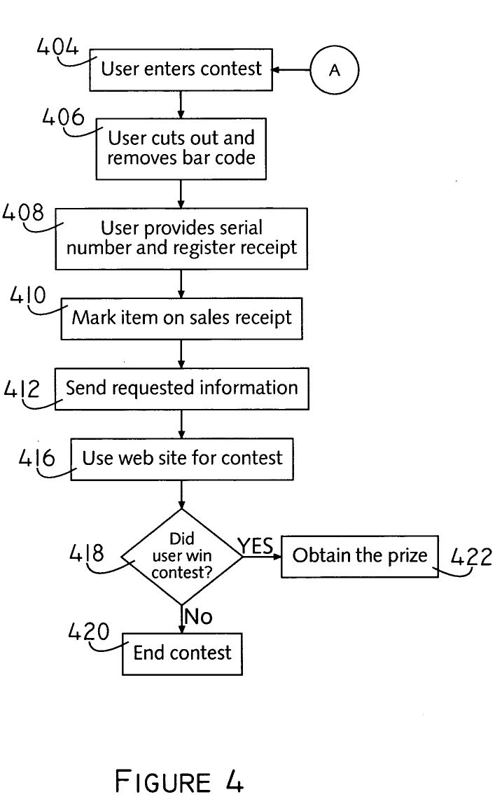

Referring now to FIG. 4, the user can enter a contest, step 404. By providing certain information along with a serial number, or multiple contest(s), the user mails or emails or calls in or otherwise conveys information requested from the telecommunications and entertainment package. In one embodiment, the user cuts out and removes the bar code on the telecommunications and entertainment package, step 406, and mails it with the required information.

For purposes of this disclosure, a “contest” is intended to include, but not be limited to, a prize, a sweepstake, a chance and consideration for the acquisition thereof. The customer can decide to enter the contest by following the directions on the commercial item package, the entertainment medium, and/or online. There may also be multiple contests available on the commercial item package or entertainment medium. The customer may enter as many of the contests as are available.

The rules of the contest(s) require certain information and the serial number, or multiple serial numbers that pertain to the package, along with a register receipt, step 408. The serial number must be the correct number or multiple numbers that match the music, movies, games, books, sports, exercise programming, and the like. More than one person can win the contest and qualify for different prizes or the same prize. A purchaser who buys the entertainment package can also qualify to win multiple prizes merely by purchasing additional goods via a predetermined web site.

The user circles, highlights, clicks on or otherwise selects an item on his sale register receipt, step 410. The user circles the register receipt and mails or emails the bar code and the register receipt to the address on the telecommunications and entertainment package, step 412.

The web site is used to enter the contest or contests, step 416. The user can email certain information through the web site following the same process described hereinabove. If the user wins the contest, step 418, he can claim his prize, step 422.

The telecommunications and entertainment package holds one or more contests periodically to award a winner(s). The winner receives a prize selected by the telecommunications and entertainment company (TEC). The prize may be a car, a recreational vehicle, cash, stock, retail products, restaurant meals, a recording deal, travel, jewelry, clothing hotel reservations, special events, amusement parks fees, a movie deal, any other items or deals or combination thereof. The contest ends, step 420, when another customer wins a prize.

The user obtains the prize selected by the TEC at the time the company chooses. The date and location are chosen by the TEC, the terms of which may differ per contest. The method of shipment may be to pick up the prize at a certain designated location, by FedEx, UPS or regular mail service, or any other method of delivery that the telecommunications and entertainment company chooses. Any sales tax due on the prize will be paid for by the user in order to receive the prize by a certain date.

Advertisements may be printed or embossed on the outside packaging of package 10. The advertisement may also be included on the calling cards and/or the actual CD/DVDs themselves, or within the entertainment media so as to be displayed, performed or heard while listening to the CD/DVD or seen on a user's video display monitor.

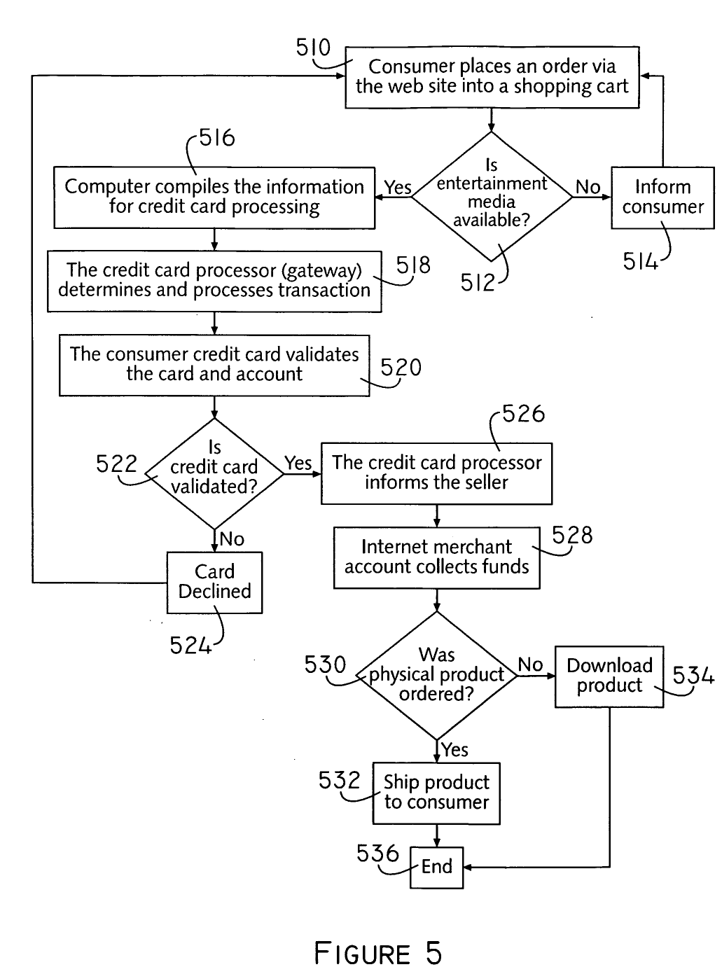

Referring now to FIG. 5, there is shown a flow chart of fulfillment operations in an Internet-based system. The consumer completes his order via a merchant's web store, step 510, specifying the number of minutes ordered and choice of entertainment.

If the provider cannot fill the entertainment order, step 512, the customer is informed, step 514, and processing resumes from step 510.

The merchant's shopping cart program on the web host computer gathers the order information, step 516, compiling it into a suitable form for the credit card processing company.

The shopping cart transmits the formatted order from the web host to the credit card processor (payment gateway), step 518. The credit card processor checks the information received regarding the order to ensure all required information is sent to continue processing the transaction. The processor then determines what company manages the customer's credit card and transmits a request for the card to be charged, step 518.

The customer's credit card company validates the card and the account, step 520. If sufficient credit is not available, step 522, the system declines the card, step 524 and resumes processing at step 510. The credit card company also sends a code back to the credit card processor indicating the nature of the problem. If everything checks out correctly and the credit card is clear for purchases, the credit card company sends an acknowledgement back to the card processor that the amount requested can be transferred, step 520.

The credit card processor notifies the merchant's shopping cart program at the web host whether the transaction was successful, step 526. The shopping cart then can notify the customer if the order was complete and can send the order on to the merchant for delivery of the product or service. The credit card processor initiates a funds transfer (settlement request) to the merchant account company for deposit into the merchant's bank account that it has on record.

Internet merchant accounts collect the funds for a specified period of time, step 528, and make scheduled transfers to the merchant's regular bank account. The credit card processing transaction is complete.

The consumer chooses a method of delivery. The consumer may prefer to have a physical product shipped directly to him, step 530, in which case the physical product is shipped directly to the consumer, step 532. The consumer may prefer to download the product, step 534. The transaction is completed, step 536.

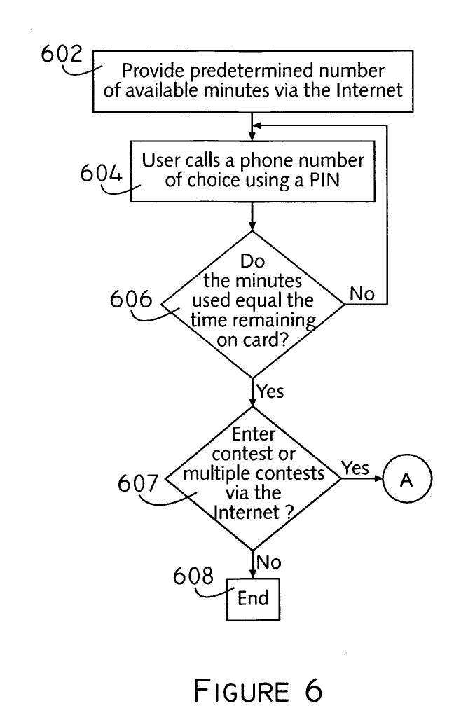

Referring now to FIG. 6, there is shown a flow chart of phone card operations. The card is provided with a predetermined number of minutes available, step 602.

A liaison company can be used to interact with retail stores and telecommunication companies. Such liaison companies typically receive a percentage of income for each minute purchased by the customer. In one embodiment of the invention, the telecommunications and entertainment company (TEC) also receives a percentage of income for each minute purchased by the consumer. A liaison is a point-of-service activation (POSA) and distribution partner for all major wireless carriers.

Phone cards can be acquired by means of the Internet and are generally a prepaid method of making a long distance (domestic or international) call. Minutes means total time that can be downloaded from the Internet and used for one or more calls to one or more phone numbers (locations, area codes, countries). The cards can be used from any phone. Some prepaid phone cards can be refilled via the Internet, usually by charging the additional cost to the user's credit card.

Landline service can be purchased, and used in connection with the present invention, in which case a discount is available to encourage a user to maintain and retain his landline service. Minutes or cash payable to a user's bill can be claimed by a user who avails himself of the inventive product and services.

The user calls a phone number using a PIN, step 604. Most prepaid phone cards display a toll-free access telephone number and PIN. The PIN can be provided by any one or more of the following techniques: printed numbers, bar codes, magnetic strips, or optical character recognition (OCR) printed symbols. Alternatively, this activation step 604 can be accomplished without the use of a predetermined PIN number and even with the use of a phone number.

If the number of minutes remaining on the card does not equal the original number of minutes paid for, step 606, the user can continue using his minutes on the call or can make another call. If, however, the number of paid minutes is used up, step 606, the system enters a contest phase, step 607, described hereinbelow. Rounding is employed for the billing increment unit. One Minute Rounding means that the billing increment is one minute. A call for fifty seconds, for example, is billed as one minute. Three Minute Rounding means that the billing increment unit is three minutes. A call for seven minutes and fifty seconds is billed as nine minutes. One plus three Minute Rounding means that for calls less than one minute, the user is charged for one minute. For calls more than one minute, the first minute is charged one minute and the following minutes are charged at three minute increments. A call for two minutes and fifty seconds is billed as four minutes.

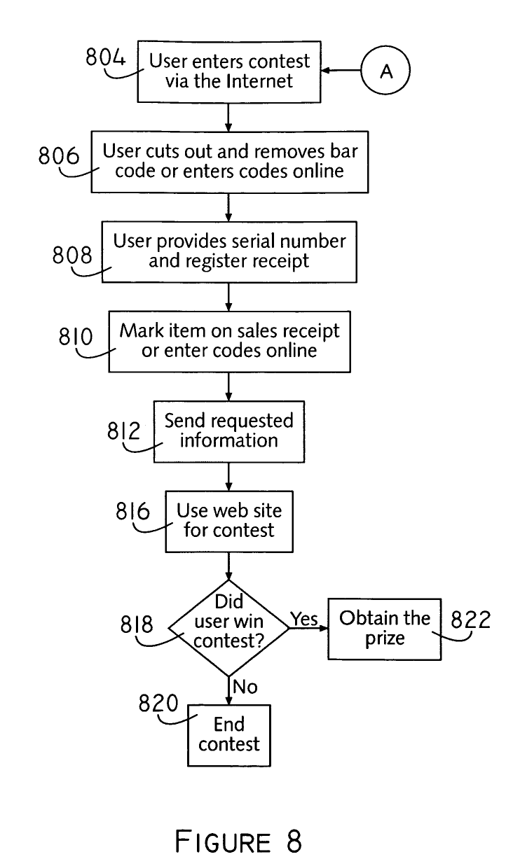

The user decides whether to enter a TEC contest via the Internet, step 607. For purposes of this disclosure, a “contest” is intended to include, but not be limited to, a prize, a sweepstake, a chance and consideration for the acquisition thereof. The user can decide to enter the contest online. There may also be multiple contests available on the package. The user may enter as many of the contests as are available. The contests include but are not limited to membership rewards, shopping cards, retailer's cards, Sirius radio, cable or Internet service, best CD album, best artists, best lyrics, best song, best movie, best actor, best soundtrack, best director, best producer, best book, best game, Ticketmaster, event tickets, and the like. If the user decides not to participate in a contest, step 607, processing determinates, step 608. Processing resumes at “A” which is shown in detail at FIG. 8.

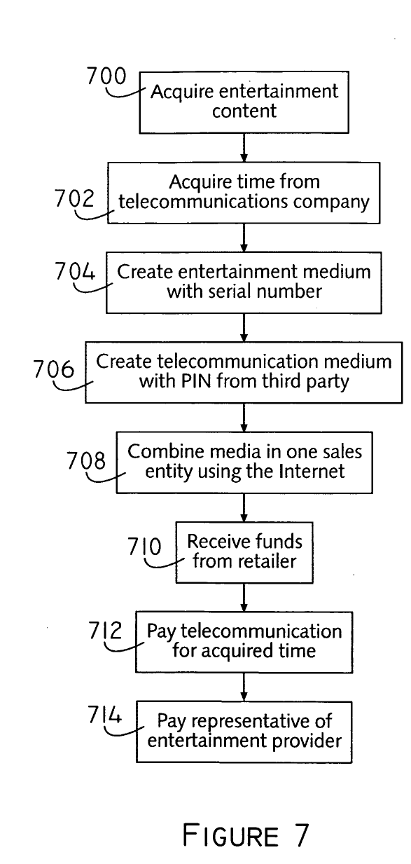

Referring now to FIG. 7, there is shown a flow chart of operations for acquiring and distributing entertainment content and telecommunications options. Entertainment content is acquired, step 700. The entertainment content may be movies on DVD, music on CD, music on mini-CD, books on DVD, stand up comedy on DVD, sports on DVD, events on DVD, exercise programming on DVD, music video on DVD, magician on DVD, history on DVD, the Bible on DVD, dance on DVD, yoga on DVD, health on DVD, educational programs on DVD, gardening on DVD, magic shows on DVD, drivers training on DVD, cooking on DVD, stand up comedy on DVD, concerts on DVD, games, computer games on DVD, Game Boy, Nintendo DS, Nintendo GameCube, Nintendo WII, Play Station 2 and 3, PSP, entertainment cards that offer services, or gift cards for the purchase of certain entertainment products, and the like.

Time is acquired from one or more telecommunications companies, step 702. The purchased time is encoded on a magnetic strip across the phone card. The time can be activated when sold, although certain phone cards are prepaid.

An entertainment medium is created with a serial number, step 704, the serial number being placed on the entertainment medium itself.

A telecommunications medium is created with a PIN number, step 706. The PIN is placed on the telecommunications card and/or bank credit card, debt card, ATM card, iTunes, eMusic card, Internet service medium, gift card, membership card, rewards card, entertainment card, Ticketmaster, promotional card, celebrity card, and the like, which may or may not match other serial numbers within the package.

The telecommunications and entertainment media are combined in one package, step 708. The entertainment contest and/or the telecommunications minutes may be obtained via the Internet. Accordingly, the telecommunication and entertainment package now contains a phone card, a DVD or CD with entertainment programming, and a rewards contest.

Funds are received from one or more retailers, step 710. The retailer reports the sale or rental of the telecommunications and entertainment package on a monthly basis, preferably, but other periodic or non-periodic time frames can be negotiated. The retailer forwards the money from the sale or rental of the telecommunication and entertainment package on a monthly or quarterly basis, but shorter or longer payment periods can be negotiated. For purposes of this disclosure, the words “sale”, “sell” and “selling” are intended to include the concepts of renting and rented.

Telecommunications companies are paid for the acquired time, step 712, by the TEC. Minutes are paid as they are used or may be paid all at once for the telecommunications and entertainment package when purchased.

A representative of the entertainment provider is paid, step 714. The provider of the entertainment receives funds after the telecommunications and entertainment package has been purchased and the money has been received from the sale.

Referring now to FIG. 8, the user can enter a contest via the Internet, step 804. By providing certain information along with a serial number, or multiple contest(s), the user mails or emails or calls in or otherwise conveys information requested from the telecommunications and entertainment package. In one embodiment, the user cuts out and removes the bar code on the telecommunications and entertainment package, step 806, and mails it with the required information. Alternatively, the serial number can be entered by the user via the Internet.

The rules of the contest(s) require certain information and the serial number, or multiple serial numbers that pertain to the package, along with a register receipt, step 808. The serial number must be the correct number or multiple numbers that match the music, movies, games, books, sports, exercise programming, and the like. More than one person can win the contest and qualify for different prizes or the same prize. A purchaser who buys the entertainment package can also qualify to win multiple prizes merely by purchasing additional goods via a predetermined web site.

The user circles, highlights, clicks on, or otherwise selects an item on his sale register receipt or enters the store identification via the Internet, step 810. The user circles the register receipt and mails or emails the bar code and the register receipt to the address on the telecommunications and entertainment package, step 812.

The web site is used to enter the contest or contests, step 816. The user can email certain information through the web site following the same process described hereinabove. If the user wins the contest, step 818, he can claim his prize, step 822; otherwise, processing terminates, step 820.

The telecommunications and entertainment package holds a contest periodically to award a winner. The winner receives a prize selected by the telecommunications and entertainment company. The prize may be a car, a recreational vehicle, cash, stock, retail products, restaurant meals, a recording deal, travel, jewelry, clothing hotel reservations, special events, amusement parks fees, a movie deal, any other items or deals or combination thereof. The contest ends, step 820, when another customer wins a prize.

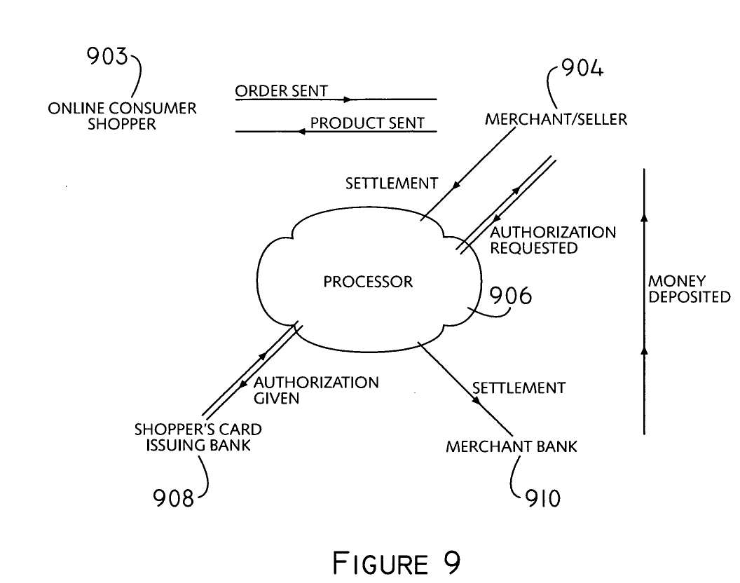

Referring now to FIG. 9, there is shown a flow chart of operations of point of purchase using a credit card. The consumer 903 makes a purchase, which is sent to the seller 904. The seller 904 sends the order to a processor 906 for authorization. The processor 906 sends the order onto the consumer's issuing bank 908 for authorization. The issuing bank 908 gives the authorization by sending the authorization back to the processor 906. The processor 906 sends the authorization onto the seller 904 that the product authorization has cleared and that the product ordered can be shipped. The seller 904 ships the product. The processor 906 sends the authorization settlement to the seller's bank 910 that a purchase has been made and has cleared. The seller's bank 910 deposits the money into the account of the seller 904.

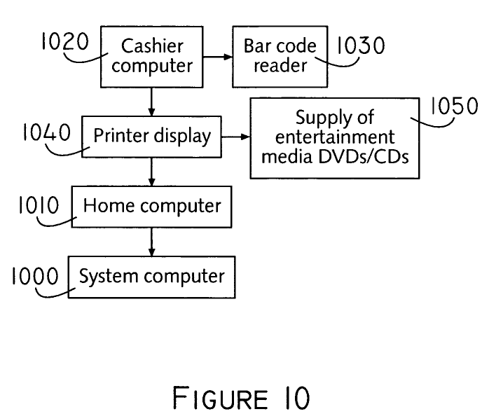

Referring now to FIG. 10, there is shown a block diagram showing flow from point of purchase of a commercial item through the consumer and thence to the medium containing entertainment content. A system computer 1000 is provided and accessible via an Internet connection. System computer 1000 includes at least one database, not shown, that contains information to allow tracking of items and transactions based on conditions, functions, attributes, labels, characters, and systems. The database(s) include information, operating systems, operations, fundamental features, limits, tables and views, indexes, other objects, external links, implementations, sources, logs, transactions, updates, documents, links to other stores, concurrency controls, query optimizers, and the like, to complete the sale of a commercial product and the providing of entertainment content. For purposes of this description, the system computer 1000 is intended to include one or more databases, as aforementioned, computers, memory, connections, hardware, providers, structures, platforms, applications, software, information systems, digital circuitry, read-only memory (ROM), embedded systems, open source hardware, design services, test delivery and logistics, network services, communications, integration, processing, and the like.

Connected to system computer 1000 via an Internet connection is a customer's home computer 1010, which may optionally be used in a method disclosed hereinbelow.

A cashier computer or checkout station 1020 is also provided at a retail store, not shown. Cashier computer 1020 is operatively connected to a device 1030 for entering information relative to a commercial item, not shown. Device 1030 may be a bar code scanner, as shown, or any equivalent device for entering such information including, but not limited to a keyboard or voice-operated I/O device, an infrared device, an optical, magnetic or SAW device.

A printer and/or display 1040 connected to the cashier computer 1020 provides information for the cashier to direct the customer to redeem his entertainment medium, such as a CD or DVD, coupon or rewards gift. Located either at the checkout station or at another part of the retail store is a supply 1050 of entertainment media.

A consumer may prefer the commercial item to be shipped directly to him or to be printable by him, via the Internet. The consumer first fills the appropriate order form and adds a shipping and handling fee. An email address is mandatory for online orders, and many times the PIN codes are sent by email. The consumer may also fill out the order form online and choose the preferred delivery method. After the consumer logs into his account, he can check his purchase history. The consumer is able to print a receipt. After a consumer logs onto his account and fills in the needed information regarding his transaction, he can print the PIN codes or card templates.

Both online “payment gateway account” (the online card processor) and an “Internet merchant account” is used. Though these are two separate components of credit card processing, they are both necessary and work together to handle payments automatically.

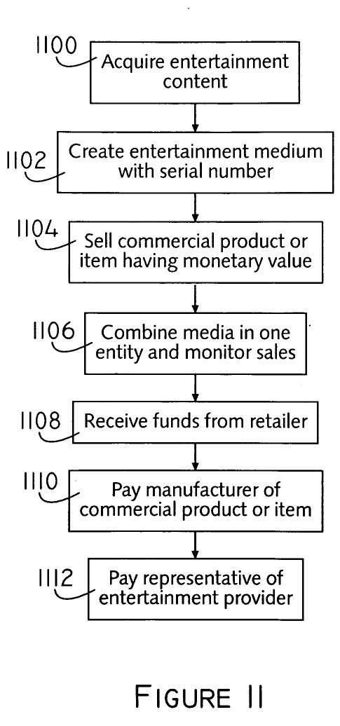

Referring now to FIG. 11, there is shown a flow chart of manufacturer/distribution operations in acquiring and distributing entertainment content and selling the commercial item. One of the first steps in practicing the inventive system is to acquire entertainment content, step 1100. The entertainment content may be movies on DVD, music on CD, music on mini-CD, books on DVD, stand up comedy on DVD, sports on DVD, events on DVD, exercise programming on DVD, music video on DVD, magician on DVD, history on DVD, the bible on DVD, dance on DVD, yoga on DVD, health on DVD, educational programs on DVD, gardening on DVD, magic shows on DVD, drivers training on DVD, cooking on DVD, stand up comedy on DVD, concerts on DVD, games, computer games on DVD, Game Boy, Nintendo DS, Nintendo GameCube, Nintendo WII, Play Station 2 and 3, PSP, entertainment cards that offer services, or gift cards for the purchase of certain entertainment products, digital files residing on electronic devices such as memory sticks, non-volatile memory cards, MP3 players, optical storage disks, multimedia cards, SanDisk, Apple iPods, solid state devices (ROMs), Bluetooth handsets, Blackberry devices, HP iPAQ, Palm, Zune to Zune, iFlops, MP3 pillows, Virgin Mobile, Slice, Zen Micro Photo MP3, T-Mobile, cellular telephones, Xbox, Nintendo WII, Nintendo DS, Nintendo GameCube, Gameboy, computer games, PSP, Play Station, TracFone, Chocolate, INpulse, Firefly, U3 Data Traveler, Digital MP3 WMA, ZenV, Walkman, MP3 FM tuner, iMove Boom Box, iPod Nano, iPod Talking Shoe, Audiovox Xpress, Micro SD, XM card, satellite radio digital music, Flicker Photos, mobile prepaid plan cards, pay-as-you-go wireless, Internet service cards, laptop cards, mobile phone cards, landline telephones, cellular phones, Virgin Mobile, Slice, iPhone, Bluetooth, camera phones, Motorola RAZR, NeXus satellite radio, MP3/DVD/CD/WMA receiver iPod and XM-ready, Ticketmaster, band credit cards, debit cards, ATM cards, Internet service, gift card, membership card, rewards card, promotion card, celebrity card, ring tones, photo card, merchandise cards, entertainment cards, Amp'd card, promotional cards, wireless gift card, You Tube, Kiosk, music downloads, movie downloads, parents cards, points cards, electronic video cards, Free Leader, GPhone, mobile caller, itune7, PDA's, Trac-Fone, WiFi, Blue Ray, mobile web and email, SanDisk Sansa, CB radio, walkie-talkie, digital cable, HBO Cinemax, DVR service, boost mobile, Xing tone software, Broadband cards, cash and non-cash rewards, Travel & Entertainment cards (T&E), house cards, Napster, Mobile TV, air travel cards, Sunnysoft calling cards, cards, Pennytalk, Microsoft Max, Photo MP3, Corel Snapfire, cash and non-cash rewards, points cards, satellite radio digital music, Internet-based applications, including Flicker Photos, iPhone, T-Mobile, STI mobile, Net10, Edge and WiFi laptop PC cards (T-Mobile), Smartphones, subscription services, Express cards, T-Mobile to Go, Text messaging, Java Games, WAV/AAC/AACT music players, walkman, PC card, USB modem, video share calling, micro SD, mini SD, Media players, DMX digital music, Sansa Connect music players, MMS, QuickShare, messaging packing MSN, YAHOO, AOL, ICQ, AIM, Billboards, multimedia messaging, data download speed burst, upload burst, 2way SMA, dual band, Quad-Band(GPRS/EDGE) worldwide communication, instant messenger, Edge technology high speed data, Yahoo Messenger, and the like.

A license is acquired from the copyright holder for the use of music, movies, books, sports, events, games, exercise programming, computer games, Gameboy games, Gameboy Advance, Nintendo DS, Nintendo GameCube, Nintendo WII, Xbox, Playstation 2, Playstation 3, PSP, and the like. The content generally resides in media in the form of a CD or DVD, but is not limited thereto. For example, other forms of expression (e.g., written material) are contemplated herein.

The entertainment medium is also created with a serial number, step 1102, the serial number, not shown, being placed on the entertainment medium itself and may be humanly readable, although the serial number may be embodied in a magnetic stripe, a bar code or any other machine-readable form.

A commercial product or item having monetary value, not shown, is then sold at the retail store or via the Internet, step 1104. Commercial items or products include but are not limited to food items, automotive, accessories, consumer electronics, electronic devices, hardware, textile, toys, sporting goods, specialty items, specialty services, stationery, crafts, books, footwear, health and beauty items, collectibles, home and garden items, jewelry, linens, clothing, pottery, glassware, computers and computer products, service, gift certificates, cameras, art, antiques, CDs, DVDs or any other media for storing entertainment content, video games, Zune to Zune, iPod, MP3, Blackberry, PDA, entertainment card, computer games, entertainment services, memory card, entertainment content, memorabilia, and the like.

The commercial items themselves may also include a serial number associated with the system computer 1000 (FIG. 10) or the entertainment medium. The retail seller may choose to shelve both commercial item and entertainment medium associated therewith together or may choose to provide the entertainment medium at a location remote from the commercial item and/or from the checkout station 1020 (FIG. 10). For purposes of this description, the commercial item or product and the entertainment medium are considered a single entity, even if provided in separate packages. Similarly, the transaction regarding the purchase of the commercial item and the delivery of the entertainment medium is considered a single transaction, even if the portions thereof are separated by time and distance (e.g., when the customer consummates downloading of the entertainment content via the Internet and his home computer 1010.

The system allows a customer to purchase a commercial product and be rewarded with free or discounted entertainment content such as reside on a DVD, CD, games, electronic devices, downloads, step 1106, which entertainment content may also be provided via a download operation by the customer at a later time and different place via the Internet and his home computer, PDA, Blackberry, telephone, iPod or other electronic device.

The system computer 1000 may be programmed to limit the number or type of rewards (i.e., entertainment content and media) according to the number, type and cost of commercial items sold to a single customer or family or household, or the frequency of such sales and locations thereof. Thus, the purchase of merely an inexpensive item such as a box of tissues may or may not be sufficient to justify a free movie on DVD, or a free CD. Similarly, credit card use many reward a customer only upon reaching certain levels of spending above say, $500. Moreover, a customer who purchases a number of items such as a pair of shoes in one day could be restricted to only one reward.

The organization receives appropriate funds from the seller or retailer, step 1108. The seller also pays the manufacturer or distributor of the commercial product or item, step 1110, although such payment can be made at an earlier stage of the process, depending upon the agreement reached between manufacturer, distributor and seller. Similarly, the organization, seller or distributor pays a representative of the entertainment provider, step 1112, pursuant to the agreement reached between entertainment media manufacturer or distributor and seller.

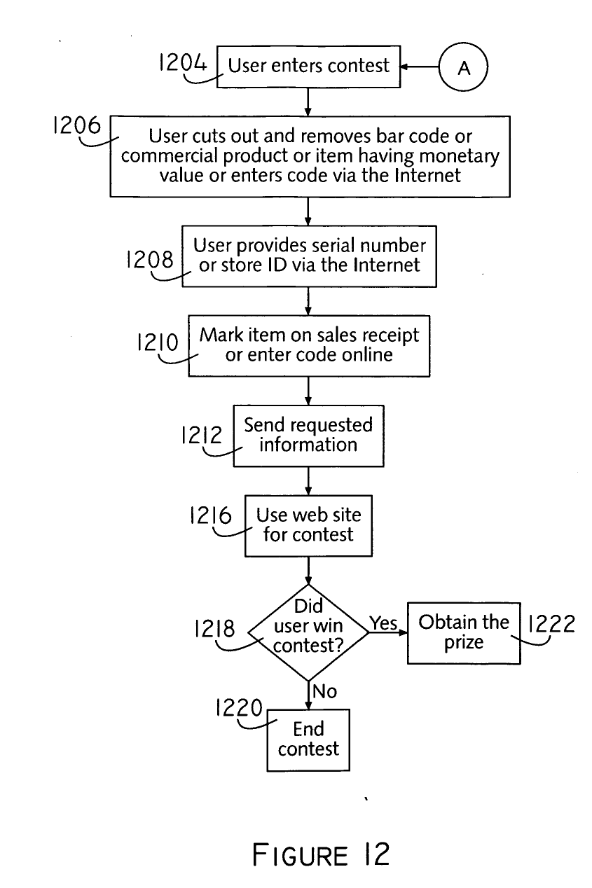

Referring now to FIG. 12, the customer can enter a contest, step 1204, which is held periodically to award a winner. The winner receives a prize selected by the inventive organization. The contests include but are not limited to a car, a recreational vehicle, cash, stock, retail products, restaurant meals, a recording deal, travel, jewelry, clothing hotel reservations, special events, amusement parks fees, a movie deal, membership rewards, shopping cards, retailer's cards, satellite radio, cable or Internet service, best CD album or DVD movie that include best artists, best lyrics, best song, best movie, best actor, best soundtrack, best director, best producer, best book, best game, Ticketmaster, event tickets, any other items or deals or combination thereof.

By providing certain information along with a serial number, or multiple contest(s), the customer mails or emails or calls in or otherwise conveys information requested from the commercial item or entertainment medium. In one embodiment, the customer cuts out and removes the bar code on the commercial product or item having monetary value or entertainment medium, step 1206, and mails it or enters it via the Internet with the required information.

The rules of the contest(s) require certain information and the serial number, or multiple serial numbers that pertain to the commercial product package and/or entertainment medium and/or item having monetary value, optionally along with a register receipt, step 1208. The serial number must be the correct number or multiple numbers that match the music, movies, games, books, sports, exercise programming, and the like. More than one person can win the contest and qualify for different prizes or the same prize. A purchaser who buys the entertainment package can also qualify to win multiple prizes merely by purchasing additional goods via a predetermined web site.

The customer circles, highlights, clicks on or otherwise selects an item on his sale register receipt or enters a code online, step 1210. The customer circles the register receipt and mails or emails the bar code and the register receipt to the address on the commercial product or item and/or entertainment medium, step 1212.

The web site is used to enter the contest or contests, step 1216. The customer can email certain information through the web site following the same process described hereinabove. If the customer wins the contest, step 1218, he can claim his prize, step 1222; otherwise, processing terminates, step 1220. The contest ends, step 1220, when another customer wins a prize.

The customer obtains the prize selected by the inventive organization at the time the company chooses. The date and location are chosen by the company, the terms of which may differ per contest. The method of shipment may be to pick up the prize at a certain designated location, by FedEx, UPS or regular mail service, or any other method of delivery that the telecommunications and entertainment company chooses. Any sales tax due on the prize will be paid for by the customer in order to receive the prize by a certain date.

The system allows the consumer to distinguish the method, model, application, channels in which the system uses to significantly reduce the operational cost for the consumer, as well as the seller. The system optimizes business transactions and automatically maximizes two products as one sale. The consumer may need to a computer, data, hardware, software, to comply with the requirements, via the Internet.

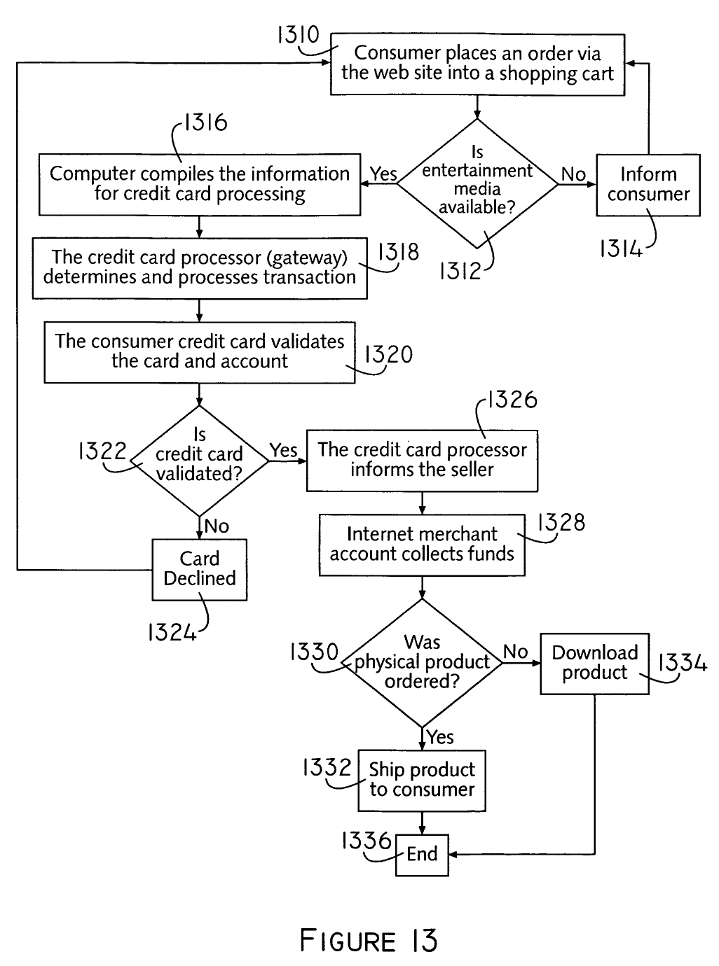

Referring now to FIG. 13, there is shown a flow chart of merchant operations for commercial items purchased over the Internet. The consumer completes his order via a merchant's web store, step 1310, specifying the item or product ordered and, optionally, choice of entertainment. If the provider cannot fill the entertainment order, step 1312, the customer is informed, step 1314, and processing resumes from step 1310.

The merchant's shopping cart program on the web host computer gathers the order information, step 1316, compiling it into a suitable form for the credit card processing company.

The shopping cart transmits the formatted order from the web host to the credit card processor (payment gateway), step 1318. The credit card processor checks the information received regarding the order to ensure all required information is sent to continue processing the transaction. The processor then determines what company manages the customer's credit card and transmits a request for the card to be charged, step 1318.

The customer's credit card company validates the card and the account, step 1320. If sufficient credit is not available, step 1322, the system declines the card, step 1324, and resumes processing at step 1310. The credit card company also sends a code back to the credit card processor indicating the nature of the problem. If everything checks out correctly and the credit card is clear for purchases, the credit card company sends an acknowledgement back to the card processor that the amount requested can be transferred, step 1320.

When the credit card is validated, step 1322, credit card processor notifies the merchant's shopping cart program at the web host whether the transaction was successful, step 1326. The shopping cart then can notify the customer if the order was complete and can send the order on to the merchant for delivery of the product or service. The credit card processor initiates a funds transfer (settlement request) to the merchant account company for deposit into the merchant's bank account that it has on record.

Internet merchant accounts collect the funds for a specified period of time, step 1328, and make scheduled transfers to the merchant's regular bank account. The credit card processing transaction is complete.

The consumer chooses a method of delivery. The consumer may prefer to have a physical product shipped directly to him, step 1330, in which case the physical product is shipped directly to the consumer, step 1332. The consumer may prefer to download the product, step 1334. The transaction is completed, step 1336.

Since other modifications and changes varied to fit particular operating requirements and environments will be apparent to those skilled in the art, this invention is not considered limited to the example chosen for purposes of this disclosure, and covers all changes and modifications which does not constitute departures from the true spirit and scope of this invention.

Having thus described the invention, what is desired to be protected by Letters Patent is presented in the subsequently appended claims.

What is claimed is:

1. A method for acquiring and distributing entertainment content with the purchase of a commercial item in a single entity or transaction, the steps comprising:
a) acquiring the rights to entertainment content; and
b) selling a commercial item and providing said entertainment content as a single entity or transaction.

2. The method for acquiring and distributing entertainment content with the purchase of a commercial item in a single entity in accordance with claim 1, the step further comprising:
c) monitoring sales of said commercial item by a single customer or household over a predetermined time period.

3. The method for acquiring and distributing entertainment content with the purchase of a commercial item in a single entity in accordance with claim 1, the steps further comprising:
c) conducting at least one contest for a customer based on information residing on said single entity.

4. The method for acquiring and distributing entertainment content with the purchase of a commercial item in a single entity in accordance with claim 1, wherein said entertainment content is embodied in a medium chosen from the group: CD, mini-CD, DVD, phone card, iPhone card, iTune card, eMusic card, debit card, credit card, Internet file, digital file residing on electronic devices, memory sticks, non-volatile memory cards, MP3 players, optical storage disks, multimedia cards, SanDisk, Apple iPods, solid state devices (ROMs), Bluetooth handsets, Blackberry devices, HP iPAQ, Palm, Zune to Zune, iFlops, MP3 pillows, Zen Micro Photo MP3, T-Mobile, cellular telephones, Xbox, Nintendo WII, Nintendo DS, Nintendo GameCube, Gameboy, computer games, PSP, Play Station 2 and 3, TracFone, Chocolate, INpulse, Firefly, U3 Data Traveler, Digital MP3 WMA, ZenV, Walkman, MP3 FM tuner, iMove Boom Box, iPod Nano, iPod Talking Shoe, Audiovox Xpress, Micro SD, XM card, satellite radio digital music, Internet-based application, Flicker Photos, Yahoo Messenger, mobile prepaid plan cards, pay-as-you-go wireless, Internet service cards, laptop cards, mobile phone cards, land line telephones, cellular phones, Virgin Mobile, Slice, Bluetooth, camera phones, iPhone, Motorola RAZR, NeXus satellite radio, MP3/DVD/CD/WMA receiver iPod and XM-ready, Ticketmaster, band credit card, ATM card, Internet service, gift card, membership card, rewards card, promotional card, celebrity card, ring tones, photo card, merchandise cards, entertainment card, music download, free loader, parents load, electronic video games, you tube, kiosks cards, mobile tracker, Amp'd card, promotional card, music downloads, movie downloads, electronic video games, You Tube, kiosks cards, cash and non-cash cards, points cards, satellite radio, GPhone, wireless gift cards, mobile caller, camera phone, itune7, PDA's, Trac-Fone, WiFi, Blue Ray, mobile web and email, SanDisk, CB radio, walkie-talkie, digital cable, HBO Cinemax, DVR service, boost mobile, Xing tone software, Broadband cards, digital music, Micro Max, Photo MP3, Coral Snapfire, Napster, Mobile TV, Travel and Entertainment cards (T&E), Pennytalk, air travel, Sunnysoft calling cards, no-fee cards, cardless cards, T-Mobile, my Faves, cellular video, STI mobile, Smartphones, Net10, Edge and WiFi laptop PC card (T-Mobile), Go Phones, DMX digital music, Sansa Connect music players, Express card, USB modem, PC card, walkman, Text messaging, Java games, T-Mobile to Go, video share calling, micro SD, Video streaming, media players, MMS, QuickShare, subscription services, mini SD, Edge technology high speed data, messaging packing MSN/YAHOO/AOL/AIM/ICQ, Billboards, multimedia messaging, data download speed burst, upload burst, 2way SMS, dual band, Quad-band (GPRS/EDGE) worldwide communication, stereo wireless, GPS enabled, WAC/AAC/AACT music player, and wireless gift card.

5. The method for acquiring and distributing entertainment content with the purchase of a commercial item in a single entity in accordance with claim 4, wherein said information residing on said single entity comprises at least one serial number.

6. A single entity for providing entertainment content with the purchase of a commercial item, comprising:
a) a first medium for holding entertainment content; and
b) a commercial item.

7. The single entity for providing entertainment content with the purchase of a commercial item in accordance with claim 6, wherein said first medium comprises at least one from the group: CD, mini-CD, DVD, phone card, iPhone card, iTune card, eMusic card, debit card, credit card, Internet file, digital file residing on electronic devices, memory sticks, non-volatile memory cards, MP3 players, optical storage disks, multimedia cards, SanDisk, Apple iPods, solid state devices (ROMs), Bluetooth handsets, Blackberry devices, HP iPAQ, Palm, Zune to Zune, iFlops, MP3 pillows, Zen Micro Photo MP3, T-Mobile, cellular telephones, Xbox, Nintendo WII, Nintendo DS, Nintendo GameCube, Gameboy, computer games, PSP, Slice, Play Station, TracFone, Chocolate, INpulse, Firefly, U3 Data Traveler, Digital MP3 WMA, ZenV, Walkman, MP3 FM tuner, iMove Boom Box, iPod Nano, iPod Talking Shoe, Audiovox Xpress, Micro SD, XM card, satellite radio digital music, Internet-based application, Flicker Photos, Yahoo Messenger, mobile prepaid plan cards, pay-as-you-go wireless, Internet service cards, laptop cards, mobile phone cards, land line telephones, cellular phones, Virgin Mobile, Slice, iPhone, Bluetooth, camera phones, Motorola RAZR, NeXus satellite radio, MP3/DVD/CD/WMA receiver iPod and XM-ready, Ticketmaster, band credit card, ATM card, Internet service, gift card, membership card, rewards card, promotional card, celebrity card, ring tones, photo card, merchandise cards, entertainment card, Amp'd card, promotional card, walkie-talkie, digital cable, mobile web and email, SanDisk, CB radio, Gphone, mobile caller, movie downloads, music downloads, Photo cards, travel and entertainment cards, You Tube, Kiosk cards, parents cards, points cards, electronic video cards, Free Leader, Itune7, PDA's, Trac-Fone, WiFi, Blue Ray, SanDisk Sansa, HBO Cinemax, DVR service, boost mobile, Xing tone software, Broadband cards, Napster, Travel and Entertainment card (T&E), Pennytalk software calling cards, air travel, house cards, Mobile TV, Microsoft Max, Photo MP3, Corel Snapfire, no-fee cards, cardless calling cards, mobile tracker, cash and non-cash cards, T-Mobile, Dash phone, my Faves, cellular video, STI mobile, Smartphones, Net10, Go Phones, Express cards, Edge and WiFi laptop PC card (T-Mobile), USB modem, PC card, walkman, text messaging, Java games, video share calling, video streaming, media players, DMX digital music, Sansa Connect music, MMS, microSD, miniSD, Edge technology high-speed data, Quick Share, messaging packing AIM/MSN/YAHOO/AOL/ICQ, Billboards, multimedia massaging, data download speed burst, upload burst, 2way SMS, dual band, Quad-Band (GPRS/EDGE) worldwide communication, subscription services, stereo wireless, GPS enabled, WAV/AAC/MCT music player, and wireless gift card.

8. The single entity for providing entertainment content with the purchase of a commercial item in accordance with claim 7, further comprising a second medium, wherein said second medium comprises at least one from the group: CD, mini-CD, DVD, phone card, iPhone card, iTune card, eMusic card, debit card, credit card, Internet file, digital files residing on electronic devices, memory sticks, non-volatile memory cards, MP3 players, optical storage disks, multimedia cards, SanDisk, Apple iPods, solid state devices (ROMs), iPhone, Bluetooth handsets, Blackberry devices, HP iPAQ, Palm, Zune to Zune, iFlops, MP3, MP3 pillows, Virgin Mobile, Slice, Zen Micro Photo MP3, T-Mobile, cellular telephones, Xbox, Nintendo WII, Nintendo DS, Nintendo GameCube, Gameboy, computer games, PSP, Play Station, TracFone, Chocolate, INpulse, Firefly, U3 Data Traveler, Digital MP3WMA, ZenV, Walkman, MP3 FM tuner, Move Boom Box, iPod Nano, iPod Talking Shoe, Audiovox Xpress, Micro SD, XM card, satellite radio digital music, Internet-based application, including Flicker Photos, NeXus satellite radio, MP3/DVD/CD/WMA receive iPod and XM-ready, Ticketmaster, band cards, band credit cards, Internet service, gift cards, laptop cards, pay-as-you-go-cards, Gphone, MP3/DVD/CD/WMA receiver iPod and XM-ready, Internet service, gift cards, rewards cards, promotional cards, membership cards, celebrity cards, entertainment cards, ring tones, photo card, merchandise card, AMP'd card, pay-as-you-go-wireless, wireless gift card, You Tube, Kiosk, music downloads, movie downloads, parents card, points card, electronic video cards, Free Loader, landline telephone, mobile caller, itune7, PDA's, Trac-Fone, WiFi, Blue Ray, mobile web and email, SanDisk Sana, CB radio, walkie-talkie, digital cable, HBO Cinemax, DVR service, boost mobile, Xing tone software, Broadband cards, cash and non-cash cards, satellite radio digital music, Napster, Microsoft Max, Photo MP3, Corel Snapfire, Mobile TV, house cards, travel and entertainment cards (T&E), Pennytalk, Sunny software calling cards, no-fee cards, cardless cards, T-Mobile, my Faves, cellular video, STI mobile, Smartphones, Net10, Edge and WiFi laptop PC card (T-Mobile), T-Mobile to Go, Go Phone, Express card, USB modem, PC card, walkman, text messaging, Java games, video share calling, micro SD, video streaming, mini SD, edge technology high speed data, MMS, media players, QuickShare, messaging packing AIM/MSN/YAHOO/AOL/ICA, Billboards, subscription services, DMX digital music, Sansa Connect music players, multimedia messaging, data download speed burst, upload burst, 2way SMS, dual band, Quad-Band (GPRS/EDGE) worldwide communication, stereo wireless, GPS enabled, WAV/AAC/AACT music player, and Yahoo Messenger.

9. The single entity for providing entertainment content with the purchase of a commercial item in accordance with claim 6, further comprising:
c) means for qualifying a customer to participate in at least one contest.

10. The single entity for providing entertainment content with the purchase of a commercial item in accordance with claim 6, further comprising at least one advertising message, wherein said at least one advertising message is disposed on or in one of the group: the label of said first medium, the label of said second medium, embedded in said first medium, embedded in said second medium, on said single package, and on an Internet web site.

11. The single entity for providing entertainment content with the purchase of a commercial item in accordance with claim 9, wherein a prize for winning said at least one contest is chosen from the group: car, recreational vehicle, cash, stock, product, meal, recording deal, travel, jewelry, hotel reservation, special event, movie deal, and any other item or deal.

12. A method for acquiring and distributing entertainment content and information representative of monetary funds in a single package, the steps comprising:
a) acquiring entertainment content;
b) acquiring information representative of monetary funds; and
c) selling said entertainment content and said information representative of monetary funds as a single package.

13. The method for acquiring and distributing entertainment content and information representative of monetary funds in a single package in accordance with claim 12, the steps further comprising:
d) conducting at least one contest for a customer based on information residing on said medium.

14. The method for acquiring and distributing entertainment content and information representative of monetary funds in a single package in accordance with claim 13, wherein said at least one contest is conducted by using the Internet.

15. The method for acquiring and distributing entertainment content and information representative of monetary funds in a single package, in accordance with claim 12, wherein said selling said entertainment content and said information representative of monetary funds as a single package step (c) is accomplished by means of the Internet.

16. A single package for providing entertainment content and information representative of monetary funds comprising:
a) a first medium obtainable for holding entertainment content; and
b) a second medium obtainable for holding information representative of monetary funds.

17. The single package for providing entertainment content and information representative of monetary funds in accordance with claim 16, further comprising:
c) means for conducting at least one contest based on information residing on said single package.

18. A single package for providing first entertainment content and second entertainment content comprising:
a) a first medium obtainable for holding first entertainment content; and
b) a second medium obtainable for holding second entertainment content.

19. The single package for providing first entertainment content and 2 second entertainment content in accordance with claim 18, further comprising:
c) means for conducting at least one contest based on information residing on said single package.

20. A single package for providing first monetary funds and second monetary funds comprising:
a) a first medium obtainable for holding first monetary funds; and
b) a second medium obtainable for holding second monetary funds.

21. The single package for providing first monetary funds and second monetary funds in accordance with claim 20, further comprising:
c) means for conducting at least one contest based on information residing on said single package.
